(19) United States
(12) Patent Application Publication
(10) Pub. No.: US 2022/0053990 A1
(43) Pub. Date: Feb. 24, 2022

(54) MOP HEAD COVERS AND METHODS OF USING MOP HEAD COVERS

(71) Applicant: Illinois Tool Works Inc., Glenview, IL (US)

(72) Inventor: Bradley Taylor Lyon, Winston-Salem, NC (US)

(21) Appl. No.: 17/356,045

(22) Filed: Jun. 23, 2021

Related U.S. Application Data
(60) Provisional application No. 63/068,653, filed on Aug. 21, 2020.

(51) Int. Cl. A47L 13/16; A47L 13/20; B32B 5/02

(52) U.S. Cl. CPC A47L 13/16; A47L 13/20; B32B 2262/0276; B32B 2432/00; B32B 5/02

(57) ABSTRACT

This disclosure relates generally to a mop head cover which may comprise an outer an outer cover comprising one or more layers of a fiber material and configured to retain a mop head within the outer cover via a retaining perimeter; and a pad comprising one or more layers, and completely enclosed and integrated within an interior of the outer cover between the outer cover and the mop head. The mop head may be disposable or may be re-usable. The mop head may be sterile. This disclosure also relates generally to a method of using a mop head cover.

### RELATED APPLICATIONS

The present application claims the benefit of U.S. Patent Application Ser. No. 63/068,653, filed Aug. 21, 2020, entitled “MOP HEAD COVERS AND METHODS OF USING MOP HEAD COVERS.” The entirety of U.S. Patent Application Ser. No. 63/068,653 is expressly incorporated herein by reference.

### FIELD OF THE DISCLOSURE

This disclosure relates generally to production of clean textiles and, more particularly, mop head covers and methods of using mop head covers.

### BACKGROUND

Cleanrooms are used in various settings. These include semiconductor fabrication plants, pharmaceutical and medical device manufacturing facilities, compounding pharmacies, aerospace, manufacturing, laboratories, and similar places where extreme cleanliness is required.

It may be desirable to clean equipment and surfaces within a cleanroom. For example, in semiconductor fabrication cleanrooms, surfaces must be frequently wiped or mopped. In order to clean, wipers, mops, and cleaning solutions may be used. For such applications, the cleaning articles themselves should be exceptionally particle-free.

### SUMMARY

Mop head covers and methods of using mop head covers are disclosed, substantially as illustrated by and described in connection with at least one of the figures, as set forth more completely in the claims.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following is a description of the examples depicted in the accompanying drawings. The figures are not necessarily to scale, and certain features and certain views of the figures may be exaggerated in scale or in schematic for clarity or conciseness.

FIG. 1 is a cross-sectional view of an example mop head, in accordance with aspects of this disclosure;

FIG. 2 is a cross-sectional view of another example mop head cover, in accordance with aspects of this disclosure;

FIG. 3 is a bottom plan view of the example mop head cover of FIG. 1;

FIG. 4 is a top plan view of the example mop head cover of FIG. 1;

FIG. 5 is a side perspective view of the example mop head cover of FIG. 1;

FIG. 6 is a bottom plan view of the example mop head cover of FIG. 1;

FIG. 7 is a top plan view of the example mop head cover of FIG. 1; and

FIG. 8 illustrates flow chart diagram depicting a process of using a mop head cover, in accordance with aspects of this disclosure.

The foregoing summary, as well as the following detailed description, will be better understood when read in conjunction with the figures. It should be understood that the claims are not limited to the arrangements and instrumentality shown in the figures.

### DETAILED DESCRIPTION

In the following detailed description, specific details may be set forth to provide a thorough understanding of the embodiments of the present disclosure. However, it will be clear to one skilled in the art when disclosed examples may be practiced without some or all of these specific details. For the sake of brevity, well-known features or processes may not be described in detail. In addition, like or identical reference numerals may be used to identify common or similar elements.

One or more specific examples of the present disclosure will be described below. In an effort to provide a concise description of these examples, all features with an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Mops are often used in the cleanroom setting. Conventionally, cleanroom mops include a cover, a pad under the cover, and pins to hold the cover and pad in place on the mop head. Removing a mop head cover and replacing it with a new cover requires removal of the pins and replacement of the pins.

Disclosed example mop head covers and methods may include a fiber material outer cover enclosing a pad and surrounded by a retaining perimeter such as an elastic band and securing an example mop head cover to the mop head with the retaining perimeter. After securing the mop head cover, a user may wipe or clean a surface and then dispose of the mop head. Disclosed example mop head covers and methods may be used for various applications, particularly cleanroom applications, including: wiping and cleaning surfaces, equipment, and parts. An integrated pad and mop head design is advantageous because it does not require removal and replacement of pins. As a result, a user can quickly, efficiently, and/or cost-effectively attach, use, and remove disclosed example mop heads and mop head covers.

Disclosed example mop head covers include an outer cover including one or more layers of a fiber material and configured to retain a mop head within the outer cover with a retaining perimeter; and a pad including one or more layers, and completely enclosed and integrated within an interior of the outer cover between the outer cover and the mop head.

In some examples, the fiber material may be polyester. The fiber material may be woven, knit, or non-woven.

In some example mop head covers, the pad includes at least one of a foam construction, a woven construction, a non-woven construction, or a knit construction. The pad may be ⅛ inch thick.

In some example mop head covers, one or more layers of the fiber material may include a single, continuous sheet of material. At least a second one of the one or more layers of the fiber material may include a single, continuous sheet of material. The first one of the layers and the second one of the layers of the outer cover may be attached together to enclose the pad within the interior of the outer cover. The first one of the layers and the second one of the layers of the outer cover may be sewn together. The first one of the layers and the second one of the second one of the layers of the outer cover may be joined together ultrasonically. The first one of the layers and the second one of the second one of the layers of the outer cover may be joined together using foam lamination. The joinder of layers according to the present disclosure can be between any two or more layers.

Disclosed example mop head covers include various cross-sectional areas that may measure 8 inches by 4.5 inches. The mop head cover may have a cross section measuring 11 inches by 6.5 inches. The mop head cover may have a cross section measuring 7 inches by 4 inches. The mop head cover may have a cross section measuring 15 inches by 8 inches. The pad of the mop head cover may have the same cross-section as the mop head. The pad may include a cross-section ⅛ inch greater than the mop head. The pad may include a cross-section ⅛ inch smaller than the mop head.

The outer layer of the mop head may or may not be sterile. The outer layer of the pad may or may not be sterile. The outer layer of the plurality of layers of material may or may not be sterile.

In some examples, the retaining perimeter of the mop head cover may include an elastic band configured to stretch around the mop head and then contract to retain the mop head within a pocket defined by the outer cover. The retaining perimeter may include a draw string design configured to open around the mop head that may be fastened to retain the mop head within a pocket defined by the outer cover.

As an example, a process of using a mop head cover may include obtaining a mop having the mop head; securing the mop head cover to the mop head with the retaining perimeter; and wiping and/or cleaning a surface with the mop. The process may further include removing the mop head cover.

While not required, the process may involve using a mop that is a cleanroom or similar environment mop. The surface may be within a cleanroom or similar environment. The process may further include wiping the surface according to the cleanroom or similar environment recommended protocols. The process may further include laundering the mop head cover and re-using the mop head cover. The laundering process may include the reduction of particles, fibers, ions, non-volatile residues, and the bio-burden level of the mop head cover. The process may further include disposing of the mop head cover.

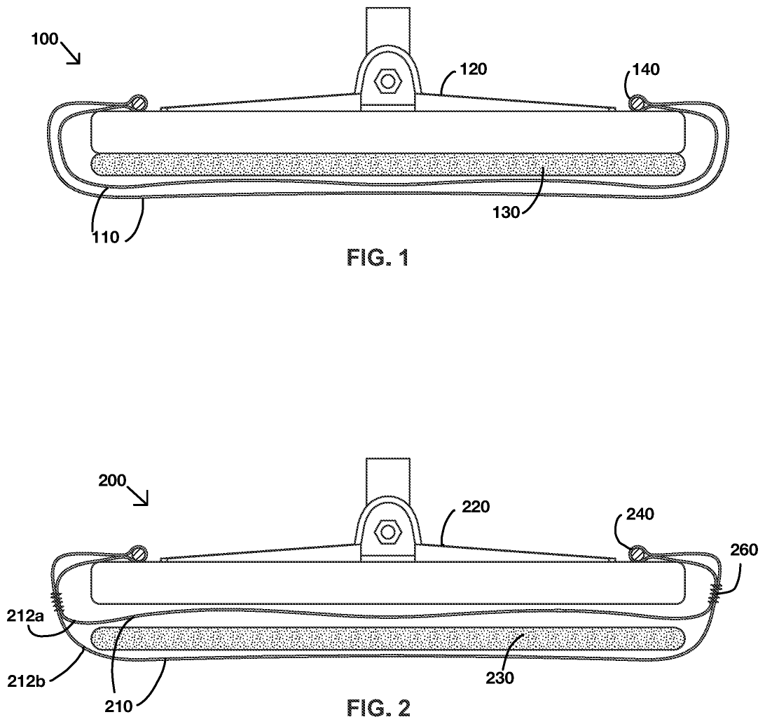

FIG. 1 is a cross-sectional view of an example mop head cover 100, in which an outer cover 110 is fitted over a mop head 120. A pad 130 is enclosed and integrated within an interior of the outer cover 110 (e.g., between the mop head 120 and the outer cover 110). The example outer cover 110 includes one or more layers of a fiber material. As used herein, “fiber material” includes fiber-based materials, such as fabric constructed from fibers. When installed over the mop head 120, the outer cover 110 retains the mop head 120 via a retaining perimeter 140.

The pad 130 may integrated, attached, and/or otherwise secured onto the outer cover 110 by, for example, sewing, adhesive, and/or ultrasonic joining. The pad 130 can also be releasably attached to the fiber material 110 in various ways including pinning, Velcro, buttoning, or clasping. The mop head cover 100 can be fitted on top of the mop head 120 in a variety of ways including elastic 140, a drawstring, pinning, buttons or clasps.

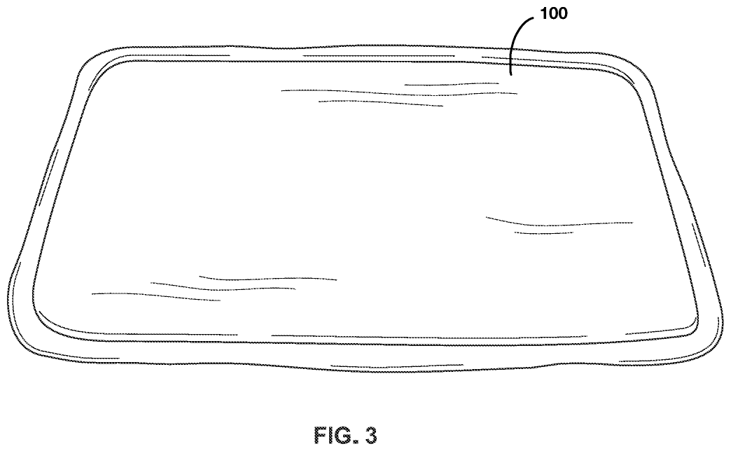

FIG. 2 is a cross-sectional view of another example mop head cover 200, in which a pad 230 is enclosed between two layers 212a, 212b making up the outer cover 210. The mop head cover 200 is fitted on top of a mop head 220, which may be similar or identical to the mop head 120 of FIG. 1. In an example mop head cover 200, the first one of the layers 212a and the second one of the layers 212b are attached together to enclose the pad within the interior of the outer cover.

The layers 212a, 212b of outer cover 210 are a fibrous material that are secured together via sewing, adhesive, ultrasonic joining, foam lamination, and/or any other technique. The joining of the layers 212a, 212b can be between two or more layers, or between a single layer that is folded to form the layers 212a, 212b. In some other examples, the outer cover 210 may include three or more layers of the outer cover 210.

Additionally or alternatively, the layers 212a, 212b may be releasably attached to one another through an attaching means 260 including pinning, Velcro, buttoning, clasping, and/or any other releasable attachment technique.

While both example mop head covers 100, 200 of FIGS. 1 and 2 may be economically produced for single-use applications, the example mop head cover 200 of FIG. 2 has the additional benefit of being reversible to enable multiple uses prior to disposal. For example, after a first use of the mop head cover 200, the mop head cover 200 may be removed from the mop head 220, turned inside-out, and replaced over the mop head 220 such that a different portion of the outer cover 210 is usable for further cleaning.

The example outer covers 110, 210 may be a polyester or other fibrous material. For example, the outer covers 110, 210 may be constructed using a woven material, a knit material, a non-woven material, and/or any combination of woven, knit, and/or non-woven materials. In the example of FIG. 1, the outer covers 110, 210 includes one continuous sheet of the fibrous material for each of the one or more layers of the outer covers 110, 210. For example, a first layer of the fiber material may be a single, continuous sheet of material and a second layer of the fiber material may be a separate single, continuous sheet of material.

The example pads 130, 230 may include one or more of a foam construction, a woven construction, a non-woven construction, and/or a knit construction. For example, a woven construction, a non-woven construction, and/or a knit construction may include one or more layers of material to provide for additional cushion between the mop heads 120, 220 and the object being wiped.

The retaining perimeters 140, 240 of the mop head covers 100, 200 may include an elastic band configured to stretch around the mop head and then contract to retain the mop head within a pocket 150, 250 defined by the outer covers 110, 210. In some other examples, The retaining perimeters 140, 240 may include a draw string, which is opened to fit around the mop head 120, 220 and fastened to retain the mop head 120 within the pocket 150, 250 defined by the outer cover. While the retaining perimeters 140, 240 are contiguous in the example of FIG. 1, in other examples the retaining perimeters 140, 240 are not contiguous and/or do not form the boundary of the outer covers 110, 210. Additionally or alternatively, the retaining perimeter 140 may also include a series of multiple elastic and/or inelastic sections attached to the outer covers 110, 210 at one or more points and/or along one or more lengths of the outer covers 110, 210.

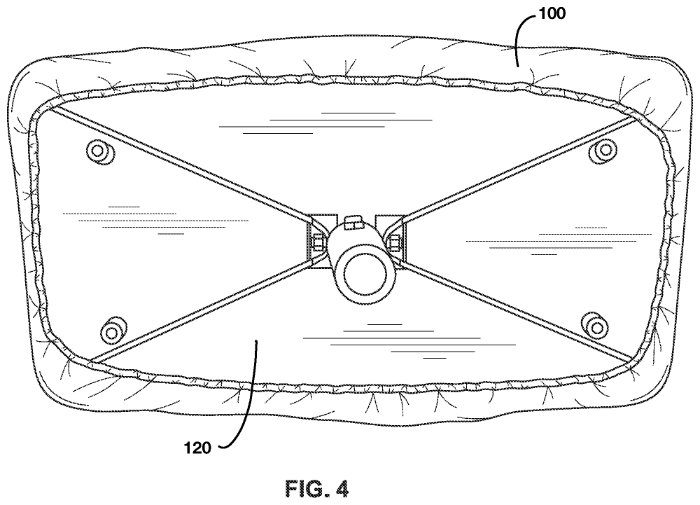

FIG. 3 is a bottom plan view of an example mop head cover 100 fitted on to a mop head (not pictured in FIG. 3), and FIG. 4 is a top plan view of an example mop head cover 100 fitted on to a mop head 120.

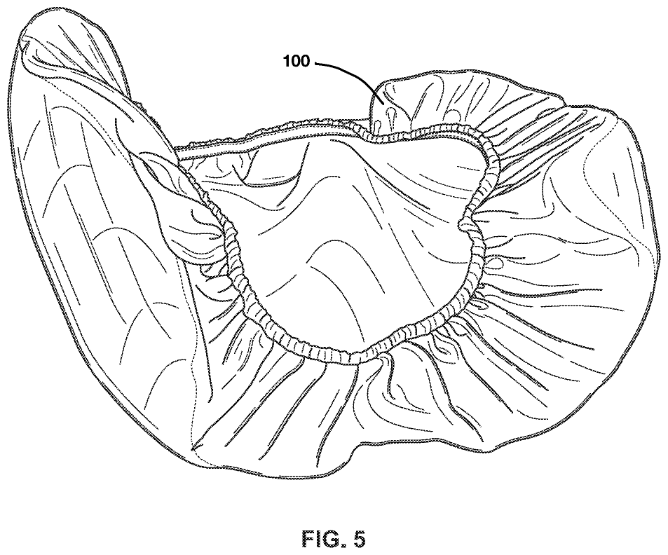

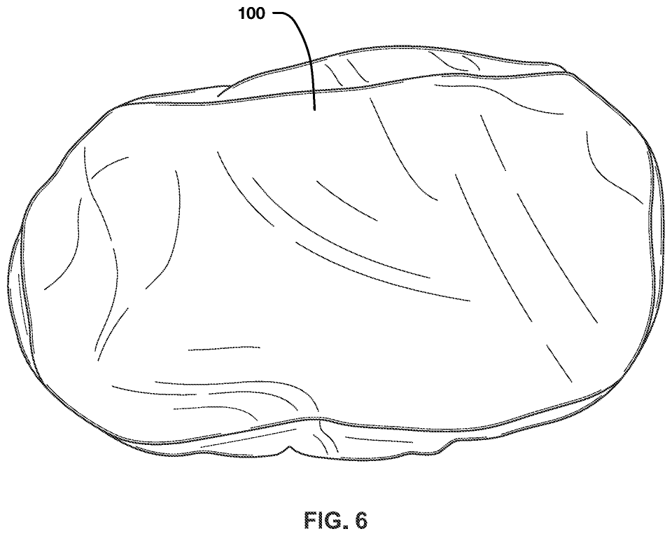

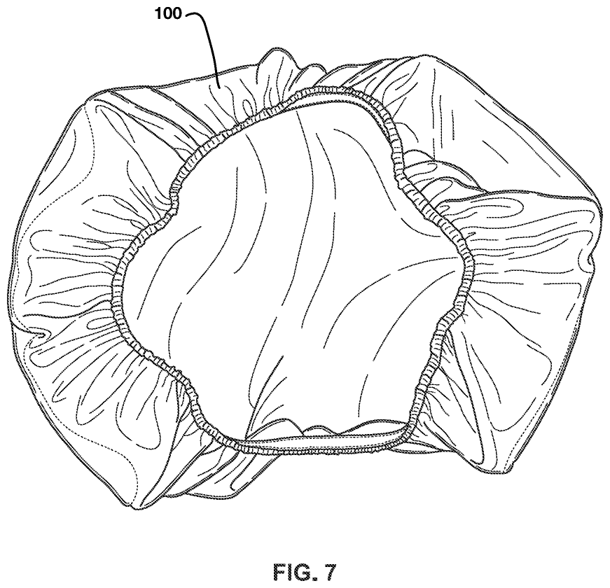

FIG. 5 is a side perspective view of an example mop head cover 100; FIG. 6 is a bottom plan view of an example mop head cover 100; and FIG. 7 is a top plan view of an example mop head cover 100.

While the material is described as a fiber material, it need not contain fibrous materials in every embodiment. It may be polymer based or include some other flexible material. The material may be of variable thickness.

There may be more than one layer of fiber material. One or more layers of the fiber material may include a single continuous sheet of material. One or more layers of the fiber material may include a disjointed sheet of more than one material.

The material of which the outer cover 210 is made depends upon the use to which the mop head cover 200 is to be put. For uses in which extremely particle-free mop head covers 200 are not required, such as in cleaning automobiles, airplanes and other vehicles prior to painting, or at other times, a highly suitable material is a hydroentangled mixture of synthetic fibers and cellulose fibers such as that sold under the trademark “TechniCloth” by the Texwipe Company. The material may be of variable thickness. The fiber material may be woven, knit, or non-woven. The fibers may be animal fibers, plant fibers, synthetic fibers or any combination of different types of fibers. The fiber may be polyester.

Other usable materials include those which are absorbent, do not fall apart easily when moistened, are resistant to the solvents absorbed into them and are sufficiently inexpensive for the use.

The pad 230 may include a foam construction, such as polyurethane. The pad may be constructed of multiple plies of a woven or nonwoven material. The pad may include a woven construction, a non-woven construction, or a knit construction. The pad may be of variable thickness. The pad may be ⅛ inch thick.

Mop head covers according to the present disclosure may come in various sizes, such as (length×width of cross-section): 8 inches×4.5 inches, 11 inches×6.5 inches, 7 inches×4 inches, and 15 inches×8 inches.

The pad of the mop head cover may have the same cross-section as the mop head. The pad may include a cross-section ⅛ inch greater than the mop head. The pad may include a cross-section ⅛ inch smaller than the mop head.

The entire mop head cover may or may not be sterile. One or more layers of the plurality of layers of material mop head cover may or may not be sterile. The pad may or may not be sterile. The outer layer of the mop head may or may not be sterile. The outer layer of the pad may or may not be sterile. The outer layer of the plurality of layers of material may or may not be sterile. Any part of the mop head cover may or may not be sterile.

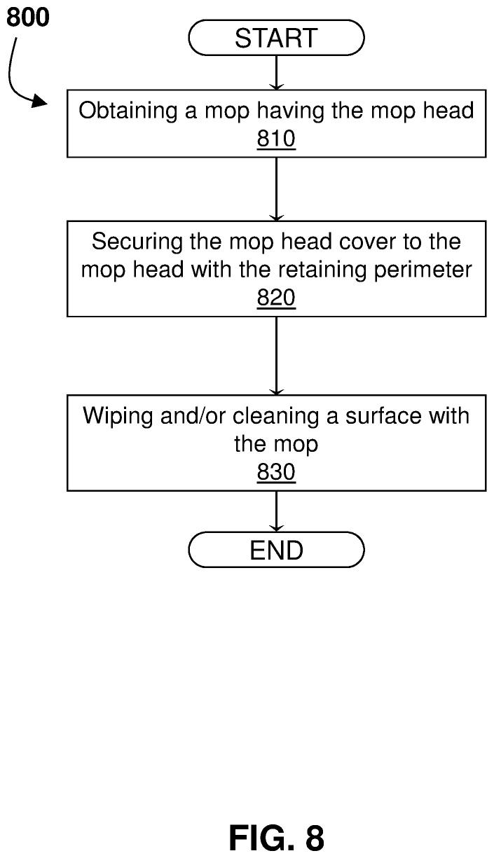

FIG. 8 illustrates flow chart diagram showing an example process 800 of using a mop head cover according to the present disclosure. Under this example process 800, a mop having a mop head is obtained at block 810. A mop head cover according to the present disclosure may be secured to the mop head via the retaining perimeter at block 820. One may wipe or clean a surface with the mop at block 830.

In an example process, the process may further include removing the mop head cover. The mop may be a cleanroom or similar environment mop. The surface to be cleaned may be within a cleanroom or similar environment. Where the surface is within a cleanroom or similar environment, the process may further include wiping or cleaning the surface according to the cleanroom or similar environment recommended protocols. The process may also further include laundering the mop head cover and re-using the mop head cover. The laundering process may include the reduction of particles, fibers, ions, non-volatile residues, and the bio-burden level of the mop head cover. The process may also include disposing of the mop head cover.

The mop head cover may be contacted with a cleaning liquid for cleaning and wiping of various surfaces. The cleaning liquid can be any of a wide variety of liquids used for cleaning purposes, including water, isopropyl alcohol, etc. Mop head covers may be packaged dry or pre-wetted and in sterile dry and pre-wetted forms. Pre-wetted mop head covers may be wetted with a degreaser or a solvent such as isopropyl alcohol (IPA), such as a 70% IPA blend, or acetone.

While the present disclosure has been described with reference to certain implementations, it will be understood by those skilled in the art that various changes may be made and equivalents may be substituted without departing from the scope of the present method or system. In addition, many modifications may be made to adapt a particular situation or material to the teachings of the present disclosure without departing from its scope. For example, systems, blocks, or other components of disclosed examples may be combined, divided, re-arranged, or otherwise modified. Therefore, the present disclosure is not limited to the particular implementations disclosed. Instead, the present disclosure will include all implementations falling within the scope of the appended claims, both literally and under the doctrine of equivalents.

1. A mop head cover comprising:
an outer cover comprising one or more layers of a fiber material and configured to retain a mop head within the outer cover via a retaining perimeter; and
a pad comprising one or more layers, and completely enclosed and integrated within an interior of the outer cover between the outer cover and the mop head.

2. The mop head cover of claim 1, wherein the fiber material is polyester.

3. The mop head cover of claim 1, wherein the fiber material is woven, knit, or non-woven.

4. The mop head cover of claim 1, wherein the pad is comprised of at least one of a foam construction, a woven construction, a non-woven construction, or a knit construction.

5. The mop head cover of claim 1, wherein the pad is at least ⅛ inch thick.

6. The mop head cover of claim 1, wherein at least a first one of the one or more layers of the fiber material comprises a single, continuous sheet of material.

7. The mop head cover of claim 6, wherein at least a second one of the one or more layers of the fiber material comprises a single, continuous sheet of material.

8. The mop head cover of claim 7, wherein the first one of the layers and the second one of the layers of the outer cover are attached together to enclose the pad within the interior of the outer cover.

9. The mop head cover of claim 8, wherein the first one of the layers and the second one of the layers of the outer covers are sewn together.

10. The mop head cover of claim 8, wherein the first one of the layers and the second one of the layers are joined together ultrasonically.

11. The mop head cover of claim 8, wherein the first one of the layers and the second one of the layers of the outer cover are joined together using foam lamination.

12. The mop head cover of claim 1, wherein the mop head cover has a cross section measuring measures 8 inches by 4.5 inches.

13. The mop head cover of claim 1, wherein the mop head cover has a cross section measuring measures 11 inches by 6.5 inches.

14. The mop head cover of claim 1, wherein the mop head cover has a cross section measuring measures 7 inches by 4 inches.

15. The mop head cover of claim 1, wherein the mop head cover has a cross section measuring measures 15 inches by 8 inches.

16. The mop head cover of claim 1, wherein the pad comprises a same cross-section as the mop head.

17. The mop head cover of claim 1, wherein the pad comprises a cross-section ⅛ inch greater than mop head.

18. The mop head cover of claim 1, wherein the pad comprises a cross-section ⅛ inch smaller than the mop head.

19. The mop head cover of claim 1, wherein the outer layer and the pad is sterile.

20-24. (canceled)

25. A process of using the mop head cover of claim 1 comprising: obtaining a mop having the mop head; securing the mop head cover to the mop head with the retaining perimeter; and wiping and/or cleaning a surface with the mop.

26-32. (canceled)
